(19) United States
(12) Patent Application Publication
(10) Pub. No.: US 2026/0146164 A1
(43) Pub. Date: May 28, 2026

(54) RADIATIVE COOLING FILM INCLUDING METAL PARTICLES AND METHOD FOR MANUFACTURING SAME

(71) Applicant: INDUSTRY-ACADEMIC COOPERATION FOUNDATION, YONSEI UNIVERSITY, Seoul (KR)

(72) Inventors: Hyung Hee CHO, Seoul (KR); In Joong CHANG, Seoul (KR); Ju Yeong NAM, Seoul (KR); Joon Soo LIM, Seoul (KR); Jin Sup SONG, Seoul (KR); Jae Hyeong KIM, Geoje-si (KR)

(21) Appl. No.: 19/400,765

(22) Filed: Nov. 25, 2025

(30) Foreign Application Priority Data
Nov. 26, 2024 (KR) 10-2024-0170308
Nov. 5, 2025 (KR) 10-2025-0164903

(51) Int. Cl. C09D 5/33; C08J 7/04; C09D 7/40; C09D 7/61; C09D 7/63

(52) U.S. Cl. CPC C09D 5/004; C08J 7/0423; C09D 7/61; C09D 7/63; C09D 7/70

(57) ABSTRACT

An embodiment relates to a radiative cooling film formed of a plurality of layers, the transparency, transmittance, etc. of which are controllable by adjusting the concentration of metal particles contained in the layers, and a manufacturing method thereof. According to the embodiment, the radiative cooling film having metal particles includes: a substrate part formed of a transparent polymer material; a particle layer formed on the substrate part, the particle layer including a plurality of metal particles; and an upper layer formed on the particle layer and formed of a transparent polymer material.

### CROSS REFERENCE TO RELATED APPLICATION

The present application claims priority to Korean Patent Application 10-2024-0170308, filed Nov. 26, 2024, and Korean Patent Application 10-2025-0164903, filed Nov. 5, 2025, in the Korean Intellectual Property Office, the entire contents of which are incorporated here for all purposes by this reference.

### BACKGROUND

The disclosure relates to a radiative cooling film having metal particles and a manufacturing method thereof, and more particularly, to a radiative cooling film formed of a plurality of layers, the transparency, transmittance, etc. of which are controllable by adjusting the concentration of metal particles included in the layers, and a manufacturing method thereof.

Global warming is accelerating as concentration of greenhouse gases such as carbon dioxide (CO₂) in the atmosphere increases. Such a phenomenon is causing abnormally high temperatures on Earth, raising serious concerns about climate change.

Building energy consumption is a major cause of CO₂ emissions, and in particular, heating and cooling systems consume a significant portion of the energy. Windows, in particular, are a major contributor to building energy loss. Recently, the number of buildings with glass facades exceeding 70% of the total window area has increased, requiring significant cooling loads.

In such a situation, most existing radiative cooling materials focus on maximizing solar energy reflection; however, applying these materials to windows blocks all light, thus losing the properties of glass. Therefore, a new radiative cooling material is needed that can provide a cooling effect while maintaining visible light transmittance.

Since radiative cooling materials may negatively impact heating loads, they must be applied in a way that takes into account external environmental conditions (season, temperature, etc.).

In addition, visual transparency must be adjusted to meet the recently emerging privacy requirements.

That is, existing radiative cooling materials only provide radiative cooling performance; the material must be able to control both cooling performance and visual transmittance as needed. Furthermore, this must be detachable and attachable to glass, allowing for easy application without special adhesives. Furthermore, a manufacturing method that allows for large-scale production is crucial.

In Korean Patent Publication No. 10-2023-0112470 (Title: RADIATION COOLING DEVICE INCLUDING PLASTIC COMPOSITE WITH DAYTIME RADIATION COOLING FUNCTION), disclosed is a radiation cooling device having a daytime radiation cooling function by mixing ceramic microparticles with a plastic material (polyurethane resin, fluororesin, polyethylene resin, polyacrylate resin, PDMS, PVC, PDMS), wherein according to an embodiment, the radiation cooling device includes a daytime radiation cooling polymer composite formed by mixing a plurality of ceramic particles, the particle size and material composition of which are determined in consideration of infrared emissivity and refractive indices related to reflectivity, transmittance, and absorptivity for incident sunlight in a wavelength range corresponding to a sky window.

### RELATED ART DOCUMENT

### Patent Document

Republic of Korea Patent Publication No. 10-2023-0112470

### SUMMARY

An aspect of the disclosure is to provide a radiative cooling film formed of a plurality of layers, the transparency, transmittance, etc. of which are controllable by adjusting the concentration of metal particles included in the layers.

The aspect of the disclosure is not limited to that mentioned above, and other aspects not mentioned will be clearly understood by those skilled in the art from the description below.

The disclosure includes: a substrate part formed of a transparent polymer material; a particle layer formed on the substrate part, the particle layer including a plurality of metal particles; and an upper layer formed on the particle layer and formed of a transparent polymer material, wherein the metal particles have at least one plane.

In an embodiment of the disclosure, an area ratio of the metal particles to the surface of the substrate part on which the particle layer is formed may be 1% to 95%.

In an embodiment of the disclosure, transmittance may be 1% to 95%.

In an embodiment of the disclosure, the metal particles may be any one metal selected from the group consisting of aluminum (Al), copper (Cu), iron (Fe), gold (Au), silver (Ag), and lead (Pb).

In an embodiment of the disclosure, the metal particles may be formed by ball milling substance particles, which are spherical particles made of metal.

In an embodiment of the disclosure, the substrate part, the upper layer, and the particle layer may be each formed of a transparent polymer material.

In an embodiment of the disclosure, the polymer material may be any one material selected from the group consisting of PDMS (polydimethylsiloxane), PET (polyethylene terephthalate), PE (polyethylene), PMMA (polymethyl methacrylate), and polyvinylidene fluoride-hexafluoropropylene (PVDF-HFP).

The disclosure includes: a coating material generation step of forming the metal particles and generating a coating material including the manufactured metal particles; and a film manufacturing step of forming a substrate part on a base substrate, forming a particle layer on the substrate part, and forming an upper layer on the particle layer to manufacture the radiative cooling film.

In an embodiment of the disclosure, the coating material generation step includes: a metal particle manufacturing step, in which the substance particles and a plurality of balls are placed into a cylinder of a ball mill and ball milled to manufacture the metal particles; and a mixing step, in which the metal particles are mixed with a transparent liquid polymer material to produce the coating material.

In an embodiment of the disclosure, in the metal particle manufacturing step, the balls may be zirconia balls (ZrO₂ Ball).

In an embodiment of the disclosure, in the metal particle manufacturing step, an additive may be further added to the cylinder.

In an embodiment of the disclosure, the additive may be white spirit or stearic acid.

In an embodiment of the disclosure, in the coating material generation step, the number of metal particles in the coating material may be adjusted to adjust solar reflectance or visual transmittance of the radiative cooling film.

In an embodiment of the disclosure, the film manufacturing step may include: a substrate part forming step of coating a polymer material on the base substrate to form the substrate part; a particle layer forming step of coating the substrate part using the coating material to form and harden the particle layer; an upper layer forming step of coating a polymer material on the particle layer to form and harden the upper layer; and a completion step of separating the radiative cooling film from the base substrate.

In an embodiment of the disclosure, in the particle layer forming step, spray coating, spin coating or drop casting may be performed using the coating material.

The effect of the disclosure is that while controlling solar energy reflection characteristics ranging from ultraviolet to visible light to near-infrared light through a particle layer, an upper layer is transparent to visible light, allowing infrared emissivity to be maintained at a high level at all times, independent of the solar energy control characteristics.

Furthermore, the effect of the disclosure is that a substrate part, upper layer, and particle layer are each formed from a polymer material such as PDMS, eliminating the need for a separate adhesive to bond the layers together, and this allows for high bonding strength through polymer molecular bonding; furthermore, since the particle layer is formed within the two polymer layers and is not directly exposed, the biocompatible properties can be ensured.

Furthermore, the effect of the disclosure is that using plate-shaped metal particles rather than spherical metal particles allows for a larger surface area, resulting in higher solar energy reflectance control performance relative to the weight of the metal particles.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a radiative cooling film according to an embodiment of the disclosure;

FIG. 2 is a schematic diagram of a method for manufacturing a radiative cooling film according to an embodiment of the disclosure;

FIGS. 3 and 4 are graphs showing changes in the optical characteristics of sunlight for a radiative cooling film when the area ratio of metal particles changes, according to an embodiment of the disclosure;

FIGS. 5 to 7 are graphs showing changes in the optical characteristics of a radiation cooling film according to the wavelength of sunlight when the area ratio of metal particles changes, according to an embodiment of the disclosure;

FIG. 8 is a graph showing infrared emissivity according to the thickness of a radiative cooling film according to an embodiment of the disclosure;

FIGS. 9A, 9B, 9C and 9D are images showing changes in a visual image of a radiative cooling film surface when the area ratio of metal particles changes, according to an embodiment of the disclosure;

FIG. 10 is a schematic diagram of equipment for evaluating the performance of a radiative cooling film according to an embodiment of the disclosure; and

FIG. 11 is a graph related to performance evaluation of a radiative cooling film according to an embodiment of the disclosure.

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a component, this does not mean that it excludes other components, unless otherwise specifically stated, but rather that it may include other components.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

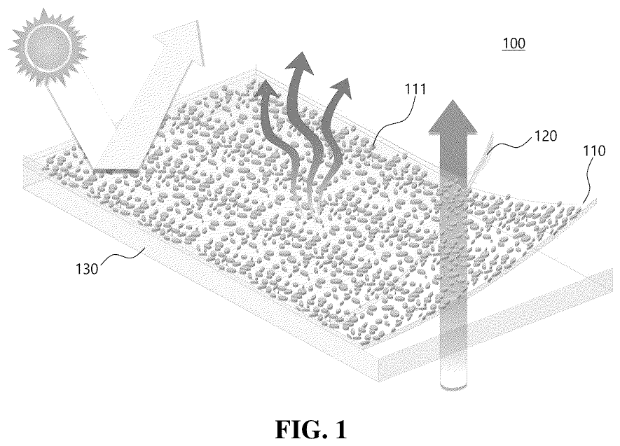

FIG. 1 is a schematic diagram of a radiative cooling film (100) according to an embodiment of the disclosure.

As shown in FIG. 1, the radiative cooling film (100) of the disclosure includes: a substrate part (130) formed of a transparent polymer material; a particle layer (110) formed on the substrate part (130) and including a plurality of metal particles (111); and an upper layer (120) formed on the particle layer (110) and formed of a transparent polymer material.

The metal particles (111) may be any metal selected from the group consisting of aluminum (Al), copper (Cu), iron (Fe), gold (Au), silver (Ag), and lead (Pb).

However, the metal forming the metal particles (111) is not limited to the materials described above, and other metals capable of reflecting light and forming the shape of the metal particles (111) may also be used.

Here, the metal particles (111) may have at least one plane. As shown in FIG. 1 and elsewhere, the metal particles (111) may be formed in the shape of a leaf, i.e., having planes on both sides and an oval cross-section perpendicular to the planes.

To form the metal particles (111) described above, substance particles (10), which are spherical particles made of metal, may be ball milled to form the metal particles (111). The ball milling process will be described in detail below.

However, in addition to generating metal particles (111) by ball milling spherical substance particles (10) as described above, non-spherical substance particles (10) may also be used, and depending on the shape of the non-spherical substance particles (10), different leaflet shapes may be formed.

However, when generating metal particles (111) using spherical substance particles (10) as described above, the shapes of each metal particle (111) are generally identical; therefore, adjusting the concentration (number) of multiple metal particles (111) may facilitate adjusting the solar reflectance or visual transmittance.

The substrate part (130), upper layer (120), and particle layer (110) may each be formed from a transparent polymer material.

Here, the polymer material may be any material selected from the group consisting of PDMS (polydimethylsiloxane), PET (polyethylene terephthalate), PE (polyethylene), PMMA (polymethyl methacrylate), and polyvinylidene fluoride-hexafluoropropylene (PVDF-HFP).

However, the polymer material is not limited to the above, and any transparent polymer-based material may be used.

Here, the substrate part (130) and the upper layer (120) may be formed as plates made of polymer material, and the particle layer (110) may be formed as plates made of polymer material, with metal particles (111) arranged internally or externally.

When using the above-described transparent polymer material, the substrate part (130) and the upper layer (120) may each be formed as transparent layers, and each may also be flexible.

Accordingly, the radiative cooling film (100) of the disclosure may be installed on surfaces of various shapes; furthermore, when installed on a glass window, it allows the outside to be seen from inside the window (visual transmission), while simultaneously allowing sunlight to be reflected by the particle layer (110).

At this time, the upper layer (120) maintains a relatively high infrared emissivity, enabling the radiative cooling film (100) of the disclosure to exhibit excellent radiative cooling performance.

With this structure, the particle layer (110) controls solar energy reflection characteristics ranging from ultraviolet rays to visible light and near-infrared rays; since the upper layer (120) is transparent to visible light, the infrared emissivity can be maintained at a high level at all times, independent of the solar energy control characteristics.

Furthermore, since the substrate part (130), upper layer (120), and particle layer (110) are each formed from a polymer material such as PDMS, high bonding strength is achieved through polymer molecular bonding without the need for a separate adhesive to bond the layers; furthermore, since the particle layer is formed within the two polymer layers and is not directly exposed, the biocompatible properties may be ensured.

Furthermore, the radiative cooling film (100) of the disclosure utilizes plate-shaped metal particles (111) rather than spherical metal particles, thereby occupying a larger surface area. This allows for higher solar energy reflectance control performance relative to the weight of the metal particles (111).

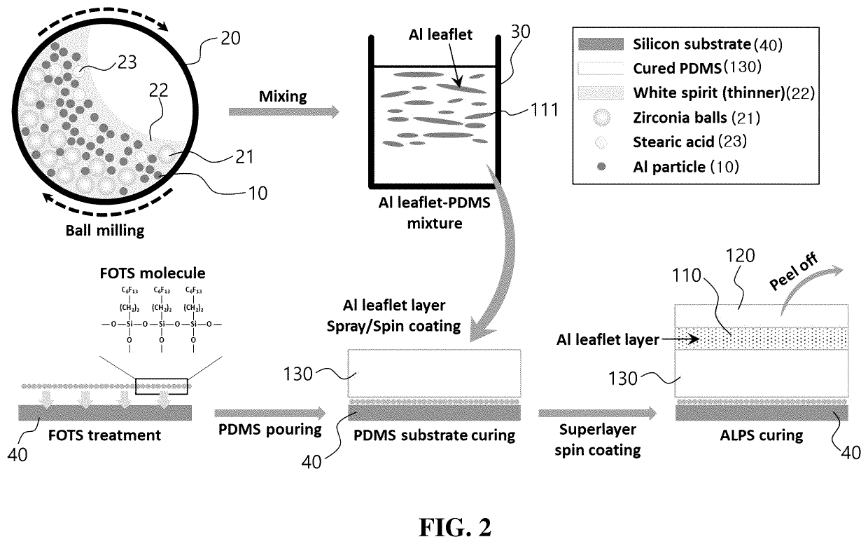

FIG. 2 is a schematic diagram of a method for manufacturing a radiative cooling film (100) according to an embodiment of the disclosure.

As shown in FIG. 2, the method for manufacturing a radiative cooling film of the disclosure may include a coating material generation step and a film manufacturing step.

In the method for manufacturing a radiative cooling film of the disclosure, which is largely formed in two steps as described above, the coating material generation step may include forming metal particles (111) and generating a coating material containing the manufactured metal particles (111).

The coating material generation step may include a metal particle manufacturing step and a mixing step.

In the metal particle manufacturing step, the metal particles (111) may be manufactured by placing substance particles (10) and a plurality of balls into a cylinder (20) of a ball mill and performing ball milling. The cylinder (20) may be cylindrical and have an internal space.

Here, multiple zirconia balls (21) are mixed and placed inside a cylinder (20), while substance particles (Al particles) (10) are placed inside the cylinder (20).

At this time, additional additives may be added to the cylinder (20). Specifically, thinners such as white spirit (22) and stearic acid (23) may be added to the cylinder (20).

The ratio of materials added during ball milling is preferably aluminum (Al): zirconia balls (ZrO₂ Ball): white spirit (White spirit):stearic acid (Stearic acid)=1:10:4:0.1. However, the ratio may be adjusted.

By rotating the cylinder (20) and performing ball milling, spherical substance particles (10) may be transformed into metal particles (111) having planes as described above, thereby forming multiple metal particles (111). At this time, the substance particles (10) may be formed in nanometers or millimeters.

During ball milling, physical and chemical phenomena may occur in the substance particles (10). Specifically, stearic acid has two different functional groups, which are a polar group of —OH and an aliphatic nonpolar group.

The polar group reacts with the hydroxyl groups on the surface of metal particles to form strong chemical bonds, while the nonpolar group can connect with the thinner (white spirit) through physical entanglement or chemical reaction.

Because of these characteristics, when ball milling is performed for a certain period of time, the metal substance particles (10) may be coated with an oil layer (thinner) by the stearic acid reacting with them.

Furthermore, the spherical substance particles (10) are compressed by zirconia balls (21), ultimately transforming them into plate-shaped particles, thereby generating metal particles (111).

In the mixing step, a coating material may be generated by mixing metal particles (111) and a transparent liquid polymer material.

Here, the number of metal particles (111) in the coating material may be adjusted to adjust the solar reflectance or visual transmittance of the radiative cooling film (100). That is, the concentration of metal particles (111) in the coating material may be adjusted.

Specifically, the coating material may be generated by adding metal particles (111) and a liquid polymer material to a mixing container (30) and mixing them.

Following the coating material generation step described above, a film manufacturing step may be performed, and the film manufacturing step may include a substrate part forming step, a particle layer forming step, and a finishing step.

In the substrate part forming step, the polymer material may be coated on the base substrate (40) to form the substrate part (130). At this time, spray coating, spin coating, or drop casting may be performed to form the substrate part (130).

The base substrate (40) may be a silicon wafer (Si wafer) coated with an anti-stick material, such as Parylene/FOTS. Alternatively, a substrate with low adhesion to polymers, such as a quartz wafer, may be used as the base substrate (40).

This facilitates subsequent separation of the radiative cooling film (100) from the base substrate (40).

In the particle layer forming step, a coating material is applied to the substrate part (130) to form a particle layer (110), which is then hardened.

Here, the coating material may be applied by spray coating, spin coating, or drop casting. Thus, the particle layer (110) may be formed on the substrate part (130). The particle layer (110) formed in this manner may then be hardened.

In the upper layer formation step, an upper layer (120) may be formed on the particle layer (110). Here, the upper layer (120) may be formed by coating the upper surface of the particle layer (110) with a polymer material, and spray coating, spin coating, or drop casting can be performed to coat the polymer material.

The upper layer (120) may then be hardened, thereby forming the radiative cooling film (100) of the disclosure, which includes a substrate part (130), particle layer (110), and upper layer (120) laminated thereon.

After performing the upper layer formation step as described above, in the final step, the radiative cooling film (100) may be peeled off from the base substrate (40).

As described above, the manufacturing method for the radiative cooling film (100) of the disclosure may be implemented through simple casting and coating processes, without complex lithography processes.

Furthermore, since spin coating, spray coating, etc. are used to form the particle layer (110), this may be suitable for large-scale fabrication and mass production.

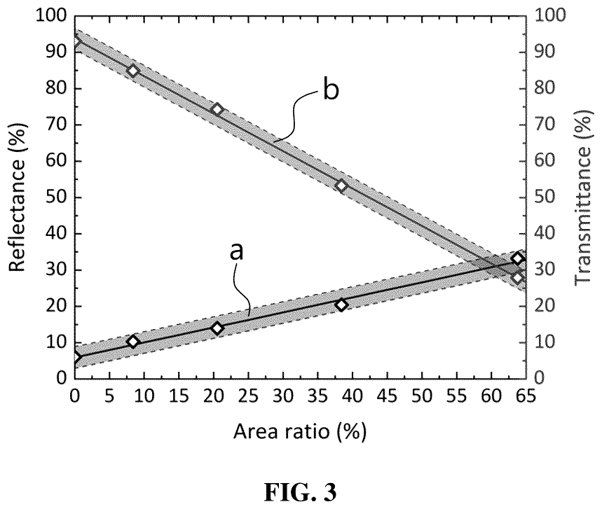

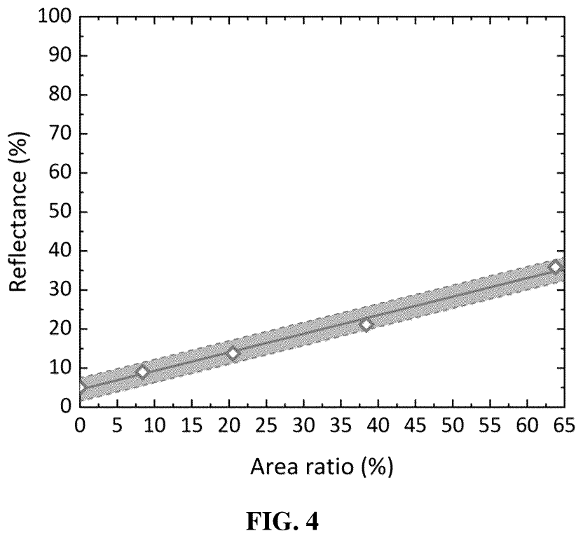

FIGS. 3 and 4 are graphs showing changes in the optical characteristics of sunlight for a radiative cooling film (100) when the area ratio of metal particles (111) changes, according to an embodiment of the disclosure. At this time, the area ratio (Area Ratio (%)) of the metal particles (111) may be proportional to the concentration of the metal particles (111) in the coating material.

Here, the area ratio of the metal particles (111) to the surface of the substrate part (130) where the particle layer (110) is formed may range from 1% to 95%. Furthermore, the transmittance of the radiative cooling film (100) of the disclosure may range from 1% to 95%.

FIG. 3 shows the solar reflectance (Reflectance (%)) and visual transmittance (Transmittance (%)) of the radiative cooling film (100) of the disclosure accoridng to a change in the area ratio (Area Ratio (%)) of the metal particles (111). In FIG. 3, graph a represents solar reflectance, and graph b represents visual transmittance.

In addition, FIG. 4 shows the near-infrared reflectance (Reflectance (%)) of the radiative cooling film (100) of the disclosure according to a change in the area ratio (Area Ratio (%)) of the metal particles (111).

As shown in FIG. 3, it is possible to confirm that the solar reflectance (Reflectance (%)) and visual transmittance (Transmittance (%)) of the radiative cooling film (100) of the disclosure may be adjusted by adjusting the concentration of the metal particles (111).

Similarly, as shown in FIG. 4, it is possible to confirm that the near-infrared reflectance (Reflectance (%)) of the radiative cooling film (100) of the disclosure may be adjusted by adjusting the concentration of the metal particles (111).

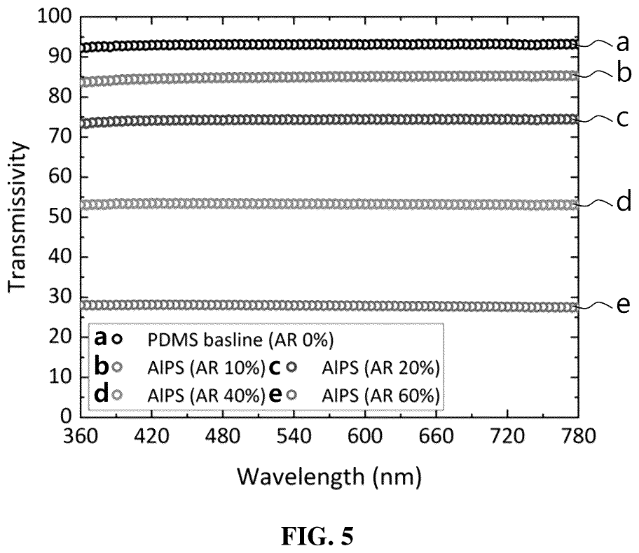

FIGS. 5 to 7 are graphs showing changes in the optical characteristics of a radiation cooling film (100) according to the wavelength of sunlight when the area ratio of metal particles (111) changes, according to an embodiment of the disclosure.

In FIGS. 5 to 7, AR(%) represents the area ratio of metal particles (111), and AIPS represents the inclusion of metal particles (111). Therefore, PDMS baseline (AR 0%) represents a radiative cooling film (100) without metal particles (111) in the particle layer (110).

Moreover, AIPS(AR 10%) represents a radiative cooling film (100) with a 10% area ratio of metal particles (111), AIPS(AR 20%) represents a radiative cooling film (100) with a 20% area ratio of metal particles (111), AIPS(AR 40%) represents a radiative cooling film (100) with a 40% area ratio of metal particles (111), and AIPS(AR 60%) represents a radiative cooling film (100) with a 60% area ratio of metal particles (111).

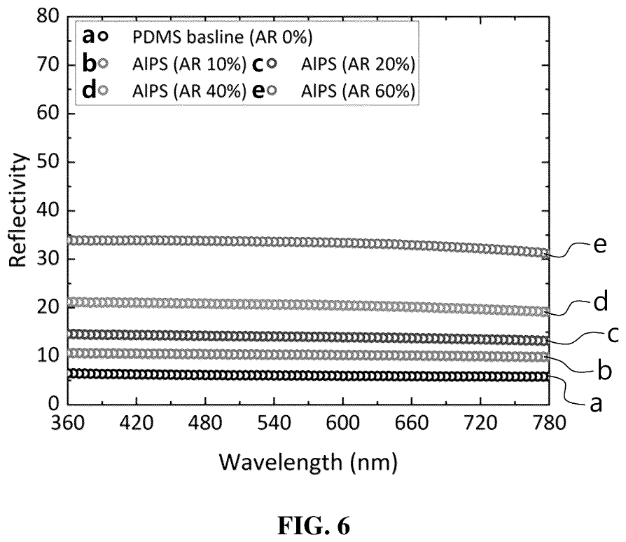

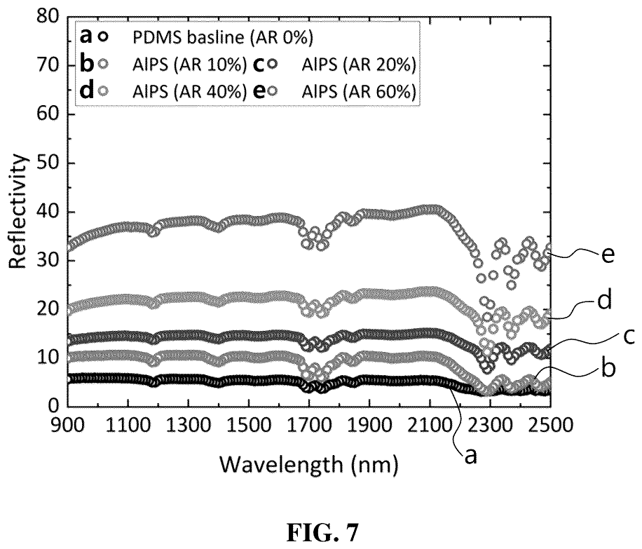

In each of the graphs in FIGS. 5 to 7, the horizontal axis represents the wavelength (Wavelength (nm)) of the solar energy band. Furthermore, the vertical axis in the graph in FIG. 5 represents the visible light transmittance (Transmissivity) of the radiative cooling film (100). In the graph in FIG. 6, the vertical axis represents the visible light reflectance (Reflectivity). In the graph in FIG. 7, the vertical axis represents the near-infrared reflectance (Reflectivity).

As shown in FIGS. 5 to 7, it is possible to confirm that the optical properties of the solar energy band may be adjusted by wavelength (Wavelength (nm)) depending on the area ratio of the metal particles (111) in the particle layer (110), i.e., the concentration of the metal particles (111) within the particle layer (110).

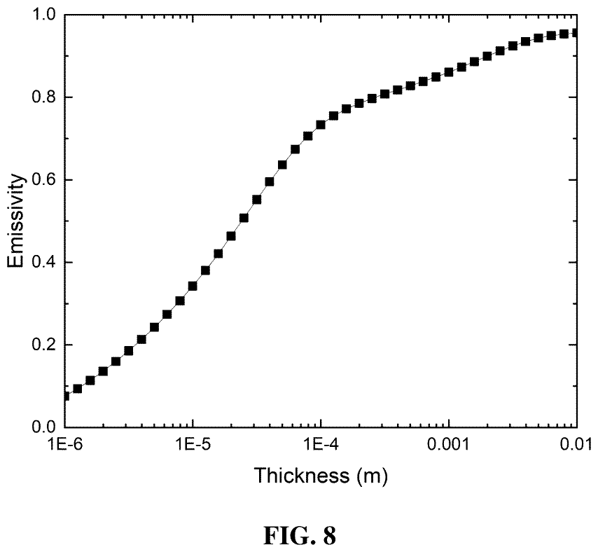

FIG. 8 is a graph showing infrared emissivity according to the thickness of a radiative cooling film (100) according to an embodiment of the disclosure. Specifically, the horizontal axis of the graph in FIG. 8 represents the thickness (Thickness (m)) of the radiative cooling film (100), and the vertical axis represents the infrared emissivity of the radiative cooling film (100).

Here, to adjust the thickness of the radiative cooling film (100) of the disclosure, the thicknesses of the substrate part (130) and the upper cover may be adjusted. As shown in FIG. 8, it is possible to confirm that the infrared emissivity of the radiative cooling film (100) of the disclosure may be adjusted by adjusting the thickness of the radiative cooling film (100) of the disclosure.

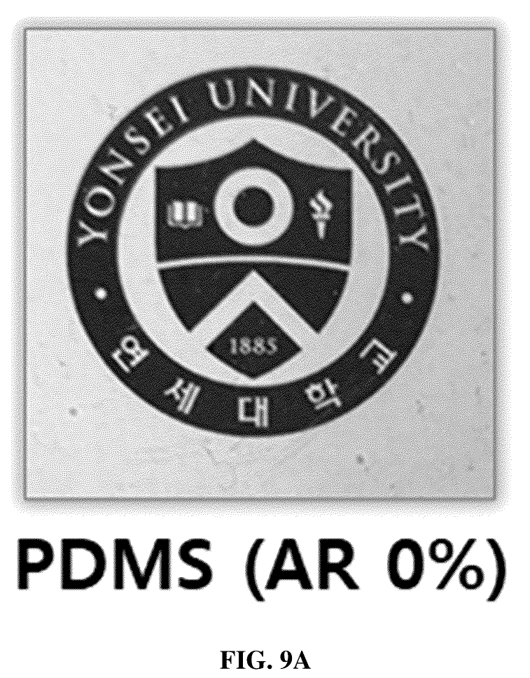

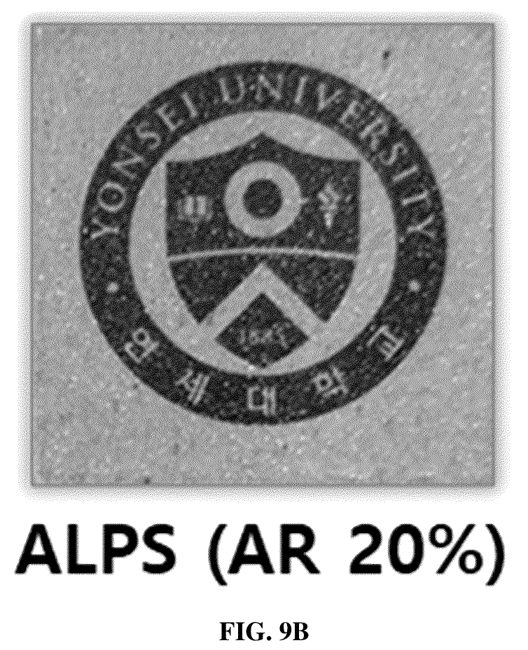

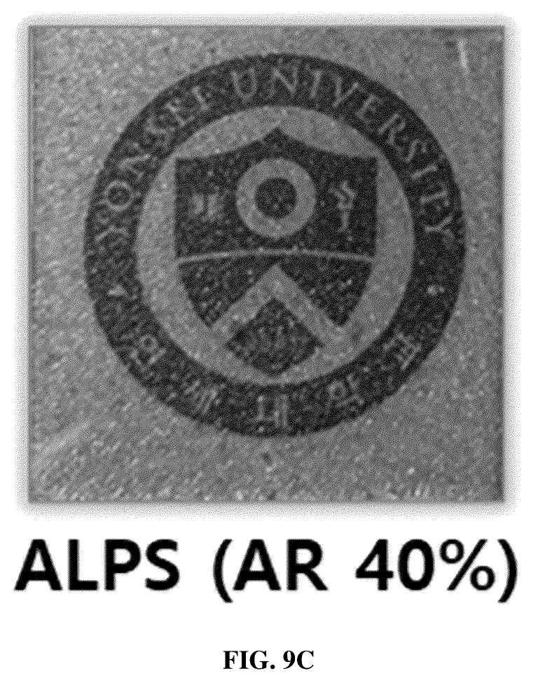

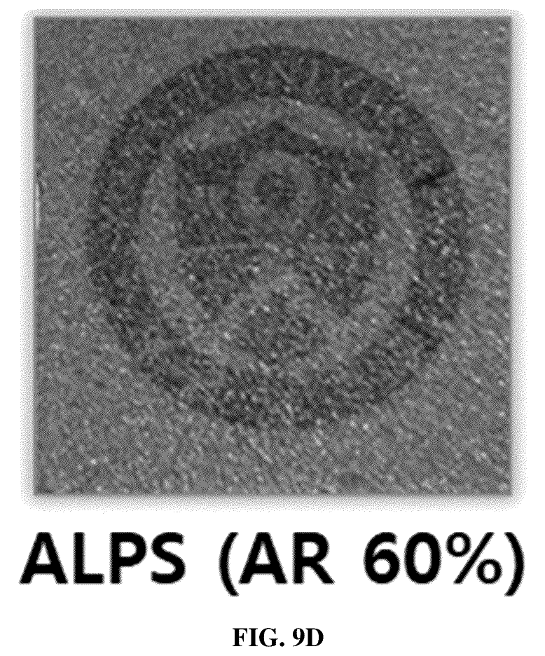

FIGS. 9A to 9D are images showing changes in a visual image of a radiative cooling film (100) surface when the area ratio of metal particles (111) changes, according to an embodiment of the disclosure. In FIGS. 9A to 9D, AR(%) represents the area ratio of metal particles (111), and ALPS indicates the inclusion of metal particles (111).

Therefore, PDMS (AR 0%) in FIG. 9A represents a radiative cooling film (100) without metal particles (111) in the particle layer (110). In addition, ALPS (AR 20%) in FIG. 9B represents a radiative cooling film (100) with a 20% area ratio of metal particles (111). ALPS (AR 40%) in FIG. 9C represents a radiative cooling film (100) with a 40% area ratio of metal particles (111). ALPS (AR 60%) in FIG. 9D represents a radiative cooling film (100) with a 60% area ratio of metal particles (111).

As shown in FIGS. 9A to 9D, it is possible to visually confirm that the visual transmittance decreases as the concentration of metal particles (111) in the radiative cooling film (100) of the disclosure increases, and accordingly, it is possible to confirm that the visual transmittance in the radiative cooling film (100) of the disclosure may be adjusted by adjusting the concentration of metal particles (111).

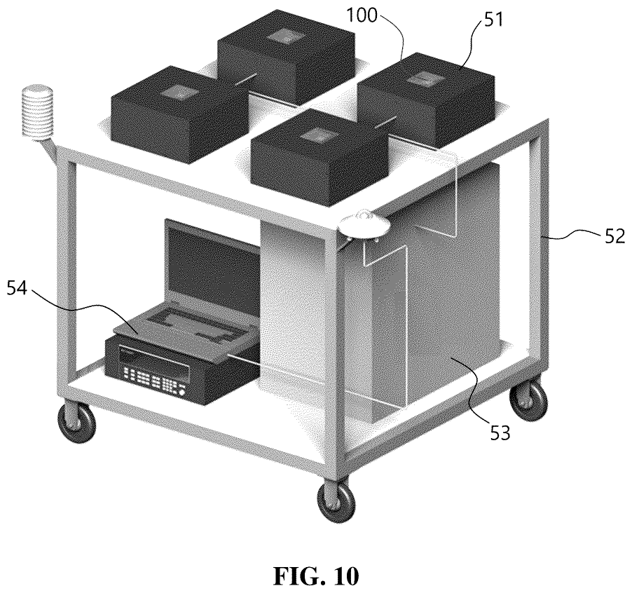

FIG. 10 is a schematic diagram of equipment for evaluating the performance of a radiative cooling film (100) according to an embodiment of the disclosure. As shown in FIG. 10, the performance evaluation equipment may include: a frame (52); an analysis part (53) installed in the inner space of the frame (52); a data part (54) installed in the inner space of the frame (52) to organize and store data from the analysis part (53); and a test part (51) installed on the upper surface of the frame (52), supporting a radiative cooling film (100), and measuring solar irradiance passing through the radiative cooling film (100) and the internal temperature.

Here, an illuminance sensor for measuring solar irradiance passing through the radiative cooling film (100) and a temperature sensor for measuring the temperature within the internal space of the test part (51) may be installed within the test part (51).

The test part (51) is a box with an internal space, with an opening formed on the sun-facing side and a glass plate formed within the opening. The radiative cooling film (100) of the disclosure may be installed on the surface of such a glass plate.

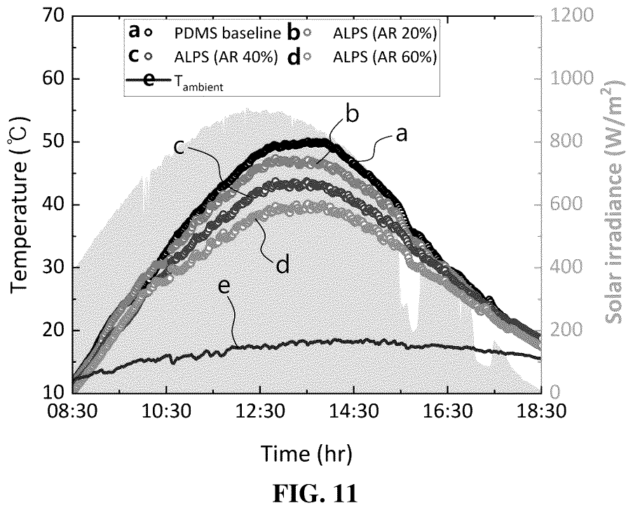

FIG. 11 is a graph related to performance evaluation of a radiative cooling film (100) according to an embodiment of the disclosure. Performance evaluation equipment, as shown in FIG. 10, was placed outdoors and measurements were conducted under conditions of sufficient solar energy reception from 8:30 AM to 6:30 PM. FIG. 11 is a graph showing the measurements taken from test part (51).

In the graph of FIG. 11, the horizontal axis represents time (Time (hr)), the left vertical axis represents temperature (° C.), and the right vertical axis represents solar irradiance (W/m2).

As shown in FIG. 11, temperature and irradiance change with increasing solar energy, and as the area ratio (concentration) of metal particles (111) increases, a radiative cooling effect, i.e., a relatively lower temperature and reduced irradiance, is observed. Specifically, the internal temperature is reduced by up to 11° C. compared to the case without metal particles (111).

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

### EXPLANATION OF REFERENCE NUMERALS

10: substance particles
20: cylinder
21: zirconia ball
22: white spirit
23: stearic acid
30: mixing container
40: base substrate
51: test part
52: frame
53: analysis part
54: data part
100: radiative cooling film
110: particle layer
111: metal particles
120: upper layer
130: substrate part

What is claimed is:

1. A radiation cooling film having metal particles, the radiation cooling film comprising:
a substrate comprising a transparent polymer material;
a particle layer disposed on the substrate, the particle layer comprising a plurality of metal particles; and
an upper layer disposed on the particle layer and comprising a transparent polymer material,
wherein the metal particles have at least one plane.

2. The radiation cooling film of claim 1, wherein an area ratio of the metal particles to a surface of the substrate on which the particle layer is disposed is in a range of 1% to 95%.

3. The radiation cooling film of claim 2, wherein transmittance is in a range of 1% to 95%.

4. The radiation cooling film of claim 1, wherein the metal particles are any one metal selected from a group consisting of aluminum (Al), copper (Cu), iron (Fe), gold (Au), silver (Ag), and lead (Pb).

5. The radiation cooling film of claim 1, wherein the metal particles are formed by ball milling substance particles, the substance particles being spherical particles made of metal.

6. The radiation cooling film of claim 1, wherein each of the substrate, the upper layer, and the particle layer comprises a transparent polymer material.

7. The radiation cooling film of claim 6, wherein the transparent polymer material is any one material selected from a group consisting of PDMS (polydimethylsiloxane), PET (polyethylene terephthalate), PE (polyethylene), PMMA (polymethyl methacrylate), and polyvinylidene fluoride-hexafluoropropylene (PVDF-HFP).

8. A method for manufacturing a radiative cooling film having the metal particles according to claim 5, the method comprising:
forming the metal particles and generating a coating material including the metal particles; and
forming the substrate on a base substrate, the particle layer on the substrate, and the upper layer on the particle layer to manufacture the radiative cooling film.

9. The method of claim 8, wherein the forming the metal particles and generating the coating material comprises:
placing the substance particles and a plurality of balls into a cylinder of a ball mill and ball milling to manufacture the metal particles; and
mixing the metal particles with a transparent liquid polymer material to produce the coating material.

10. The method of claim 9, wherein in the placing the substance particles and the plurality of balls into the cylinder, the plurality of balls are zirconia balls (ZrO₂ Ball).

11. The method of claim 9, wherein in the placing the substance particles and the plurality of balls into the cylinder, an additive is further added to the cylinder.

12. The method of claim 11, wherein the additive is white spirit or stearic acid.

13. The method of claim 9, wherein in the forming the metal particles and generating the coating material, a number of the metal particles in the coating material is adjusted to adjust solar reflectance or visual transmittance of the radiative cooling film.

14. The method of claim 8, wherein the forming the substrate on the base substrate, the particle layer on the substrate, and the upper layer on the particle layer comprises:
coating a polymer material on the base substrate to form the substrate;
coating the substrate using the coating material to form and harden the particle layer;
coating a polymer material on the particle layer to form and harden the upper layer; and
separating the radiative cooling film from the base substrate.

15. The method of claim 14, wherein in the coating the substrate using the coating material, spray coating, spin coating or drop casting is performed using the coating material.
